(19) United States
(12) Patent Application Publication
(10) Pub. No.: US 2015/0194801 A1
(43) Pub. Date: Jul. 9, 2015

(54) REVERSE CURRENT FAULT PREVENTION IN POWER COMBINATION OF SOLAR PANEL ARRAY SYSTEMS

(71) Applicant: SolarBOS, Inc., Livermore, CA (US)

(72) Inventor: Jason Schripsema, Truckee, CA (US)

(21) Appl. No.: 14/412,246

(22) PCT Filed: Jul. 9, 2013
(86) PCT No.: PCT/US13/49658

§ 371 Date: Dec. 31, 2014

Related U.S. Application Data
(60) Provisional application No. 61/669,482, filed on Jul. 9, 2012.

(51) Int. Cl. H02H 3/18

(52) U.S. Cl. CPC H02H 3/18

(57) ABSTRACT

A system for combining multiple direct current power sources is provided. The system may include a current sensor operable to monitor the current from each source to evaluate whether there is a malfunction or other problem associated with a particular source. The malfunction may be represented by a current which is flowing reverse to the correct direction, which direction may be detected by the sensor. A switch may be configured to open to disconnect the particular source upon detection of a reverse current by the sensor, thereby providing current fault protection in the system.

### RELATED APPLICATION

This application claims the benefit of priority of U.S. Provisional Application No. 61/669,482, filed on Jul. 9, 2012, the entire contents of which application(s) are incorporated herein by reference.

### FIELD OF THE INVENTION

The present invention relates generally to detecting abnormal current flow, and more particularly, but not exclusively, to detecting a reverse current flow in systems for combining multiple power sources to provide a single output, such as systems for combining the power generated by multiple solar panel arrays.

### BACKGROUND OF THE INVENTION

The use of solar panels to produce electricity continues to expand as individuals and businesses seek ways to reduce electrical costs and greenhouse gas emissions. As the use of solar power increases, so do the size of the arrays used to produce the solar power. In order to harness the energy it is desirable to combine the electrical output from portions of the array, and to detect any faults in such systems at an early stage to minimize potential damage from such faults.

### SUMMARY OF THE INVENTION

In one of its aspects, the present invention relates to a system for combining multiple source circuits of solar panels arrays to produce a single combined output circuit. In particular, the present invention may operate to detect a fault by detecting current that is flowing in the opposite (reverse) direction to the designed or expected current flow. In this regard, the present invention may provide a system for sensing and interrupting a reverse current produced by a plurality of photovoltaic elements. The system may include a plurality of sensors each disposed in electrical communication with a respective conductor of a first polarity. The sensors may be configured to detect the direction of the current flow in the respective conductor of a first polarity and be configured to provide an output of the detected direction of the current. In addition, a plurality of switches may each be disposed in electrical communication with a respective one of the sensors to receive the detected direction of the current. The switches may be configured to disconnect the current from the respective conductor of the first polarity responsive to the detected direction, which may be a reverse direction current flow. The switches may include a plurality of contactors and/or may include normally open contactors, and the sensors may include Hall effect sensors.

The system may also include a comparator disposed in electrical communication with a respective sensor and respective switch to receive the detected direction of the current. The comparator may be configured to provide an output to a respective switch which is indicative of a current flow back toward the conductor, and may be configured to turn the switch off in case of reverse current flow. Further, a plurality of over-current protection elements may each be electrically connected with a respective one of the conductors of a first polarity, and may be operable to create an open circuit in the event a current passing therethrough exceeds a threshold.

Additionally, the system may include a first busbar for electrical communication with each of the conductors of a first polarity so that the direct current from the photovoltaic elements is combined to form a single current at the busbar. In such a case, the plurality of sensors may be disposed between the first busbar and an associated switch of the plurality of switches. A second busbar may also be provided for electrical communication with a conductor of a second polarity opposite the first polarity. Each of the plurality of sensors may be disposed in electrical communication with the first busbar and each of the plurality of switches may be disposed in electrical communication with the second busbar.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates a plan view of an exemplary system for combining direct current power including a reverse current sensor in accordance with the present invention;

FIG. 2 schematically illustrates a diagram of a portion of the system illustrated in FIG. 1;

FIG. 3 schematically illustrates an exemplary contactor, current sensor, and over-current protection element assembly in accordance with the present invention;

FIG. 4 schematically illustrates the current sensor assembly of FIG. 3;

FIG. 5 schematically illustrates a block diagram showing elements and function of a reverse current sensor in accordance with the present invention; and

FIG. 6 schematically illustrates a circuit diagram of a reverse current sensor in accordance with the present invention corresponding to the block diagram of FIG. 5.

### DETAILED DESCRIPTION OF THE INVENTION

Applicant has discovered that it is possible to provide an added level of protection in power combiner/re-combiner systems, especially those where current is provided by solar panel arrays. Specifically, Applicant has discovered that one type of fault is characterized by current flowing in a direction opposite to that in which it should be traveling. Moreover, this reverse current flow can be detected early at low current levels, to provide an additional level of protection over traditional over-current protection elements, such as fuses. Detecting and acting on the presence of a reverse current flow can be particularly desirable in solar panel systems where the current generation is not constant over a 24-hour period. Specifically, source current typically begins to flow at dawn when sunlight begins to illuminate the solar panels, and this current is relatively small compared to that expected to flow at solar noon. However, traditional fuses are typically only designed to provide protection at over-current conditions likely to occur at solar noon. In contrast, in accordance with the present invention, a reverse current flow indicative of a fault can be detected at lower current levels and much earlier, e.g., at solar dawn, and the early detection and intervention can prevent damage from the fault responsible for the reverse current flow.

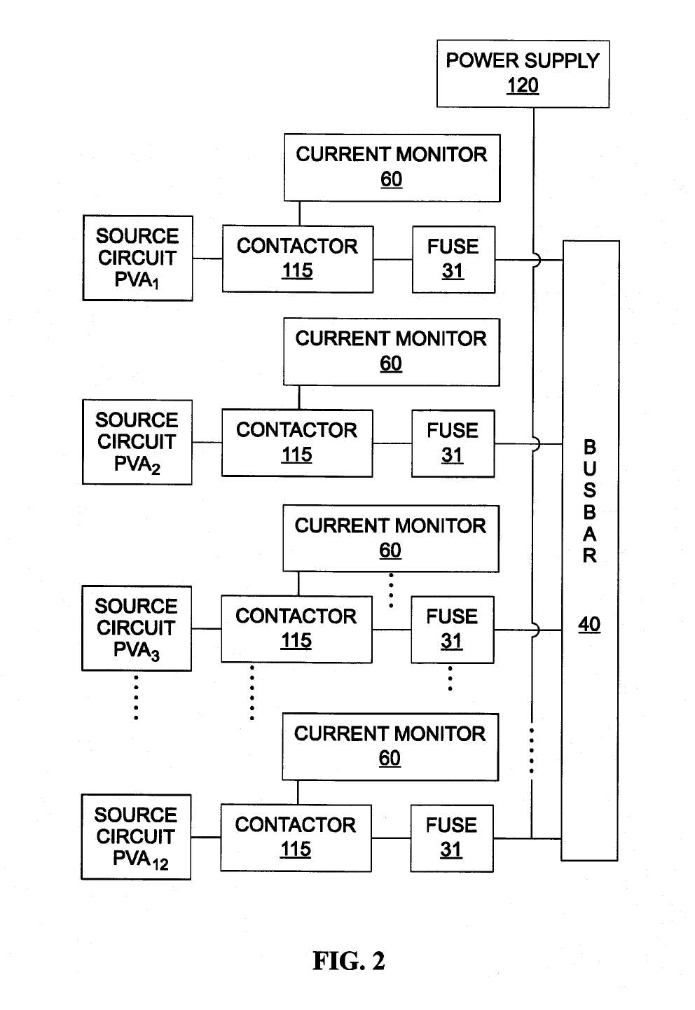

Accordingly, in one of its aspects the present invention provides a system for detecting a reverse current flow and isolating the source of the reverse current flow from other components of the system. Specifically, referring now to the figures, wherein like elements are numbered alike throughout, an exemplary system for re-combining direct current power is designated generally 10. The system 10 illustrates one exemplary solar power application in which reverse current sensing of the present invention may be used. The system 10 may include a re-combiner box 20 for receiving the power output from a plurality of power producing devices, such as the output circuits from a plurality of string combiner boxes designated PVA1, PVA2, PVA3, . . . PVA12, FIG. 2.

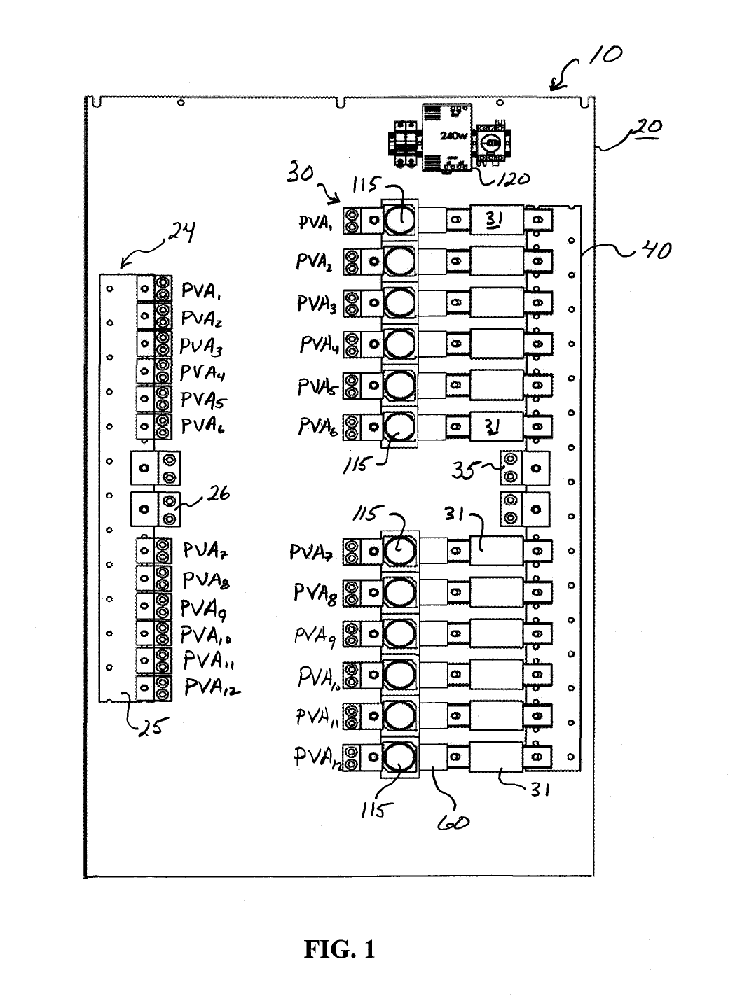

Referring now to FIG. 1, the details of the power combination aspects of the system 10 will be described in greater detail prior to discussion of the reverse current sensing aspects. The electrical generating elements may be any of a variety of devices for producing electricity. In the present instance, the electrical generating elements may be photovoltaic (PV) cells. More specifically, the electrical generating elements may be a plurality of solar panels, which may be interconnected to provide a single electrical output, PVA1. Each of these outputs may then be connected by the system 10 to provide a combined output from the output circuits PVA1-PVA12. Although the present system 10 is particularly suited for solar power applications, the system 10 is also operable with non-solar power producing elements. In non-solar applications, PVA1-PVA12 may represent alternative power producing elements.

The output from a plurality of solar panels may be combined into a single output circuit, PVA1-PVA12, by a combiner box, such as the string combiner box Part No. CS-12-15-N3 sold by SolarBOS Inc. of Livermore, Calif. The output circuits PVA1-PVA12 of each of these string combiner boxes may then be connected to the system 10 to again combine the output from each of the combiner boxes. For instance, each string combiner box may combine the input from a plurality of photovoltaic arrays and provide a combined DC output of approximately 600V/200A. The system 10 may again combine these output circuits PVA1-PVA12 to create a larger combined output.

The re-combiner box 20 may include a negative terminal assembly 24 and a positive terminal assembly 30, FIG. 1. The output circuits PVA1-PVA12 may be connected with the positive and negative terminal assemblies 24, 30 and combined to produce a single DC output. The negative terminal assembly 24 may include a terminal block 25 to provide a common conductor for all of the negative conductors from the output circuits PVA1-PVA12. The negative terminal assembly 24 may include a plurality of sockets and corresponding connectors for receiving and retaining a conductor from each of the output circuits PVA1-PVA12. Additionally, the negative terminal assembly 24 may include one or more output lugs 26 at an output of the terminal block 25. The lugs 26 may be connected to an output negative conductor. In the present instance, the negative terminal assembly 24 may include two dual output lugs 26.

The positive terminal assembly 30 may include a bus bar 40 attached to a plurality of over-current protection elements, such as circuit breakers or fuses 31, for example. In the present illustration, the exemplary over-current protection elements are illustrated as fuses 31, FIGS. 1, 2. The positive terminal assembly 30 may be configured so that all of the positive conductors connect to the positive terminal assembly 30 on two sides. However, in the present illustration, the positive terminal assembly 30 includes a single-sided configuration with connections for a plurality of inputs on a single side. One or more output lugs 35 may be electrically connected to the busbar 40 to provide a unitary output connection from the busbar 40. In the present instance, the positive terminal assembly 30 may include two dual output lugs 35, similar to the negative terminal assembly 24. The output lugs 35 may include a socket for receiving a conductor and a connector, such as a set screw or other threaded element, for retaining an output conductor in the socket of the output lug 35. In this way, an output conductor can provide an output for the combined current of the power connected to the positive terminal assembly 30 from the output circuits PVA1-PVA12. The positive output conductor and the negative output conductor can be connected with a downstream element in the circuit. For instance, the output from the re-combiner box 20 may be connected with an inverter. The inverter may convert the power from direct current to alternating current. Although the output from the re-combiner box 20 may be connected with an inverter, the system is not limited to a circuit in which the output is fed to an inverter. In view of the fact that a number of output circuits PVA1-PVA12 may be combined in the re-combiner box 20, a fault in any one of such output circuits PVA1-PVA12 could lead to overall system failure. Therefore it would be desirable to detect at an early stage individual output circuits PVA1-PVA12 which are showing signs of fault, such as a reverse current flow, and then isolate such output circuits PVA1-PVA12 from the system 10 before damage of other system elements occurs.

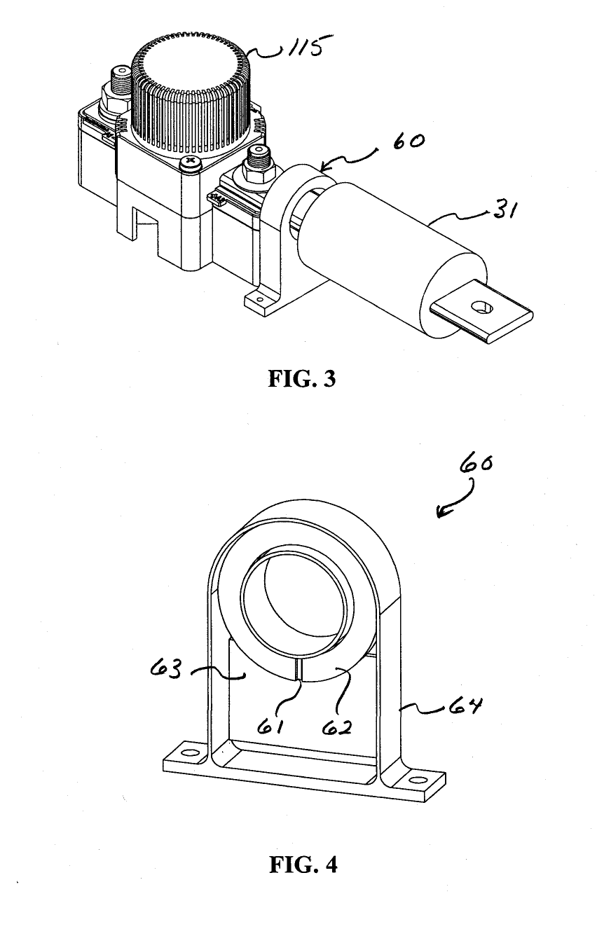

Turning then to the reverse current flow aspect of the present invention, the system 10 may also include a current sensor assembly 60 for monitoring the current flowing to the positive terminal assembly 30, FIGS. 3, 4. The current sensor assembly 60 may be configured to detect whether there is a reduction in the current supplied by one or more of the input circuits to the system. More specifically, the current monitoring system 60 may detect whether current is flowing from the positive terminal assembly 30 back to one of the output circuits PVA1-PVA12, i.e., a reverse current flow. For example, if the current sensor assembly 60 detects a malfunction, a controller may automatically disconnect the malfunctioning output circuit PVA1-PVA12 from the re-combiner box 20.

The current sensor assembly may utilize a central current sensor assembly that interconnects a plurality of sensors. Alternatively, as illustrated in the present exemplary system 10, a current sensor assembly 60 may be provided at each input of either of the negative or positive terminal assemblies 24, 30, FIGS. 1, 2. Each current sensor assembly 60 may include a sensor 61 operable to detect a characteristic of the electrical flow between the input (e.g., PVA1-PVA12) and the positive terminal assembly 30, FIGS. 1-4. The sensor 61 may be any of a variety of current detecting sensors; for instance, the current detecting sensor 61 may be a Hall effect sensor. To assist in current detection, a gapped toroid 62 may be disposed about the sensor 61 to concentrate and focus the magnetic field at the sensor 61.

The current sensor 61 may be mounted via a mount 64 to a circuit board 63 that may include control elements or signal processing elements that process the signals from the sensor 61, so that the control elements receive and analyze the signals from the sensor 61 to detect whether the signal indicates a reverse current flow (or fluctuation in the input current and/or voltage) that would be indicative of a problem with an output circuit PVA1-PVA12 at the input connected with the positive terminal 30. In other words, if PVA1 is connected to a first busbar input, and the current sensor assembly 60 associated with the first busbar input detects a reverse current flow, then the circuit board 63 may process the signal from the first sensor 61 and provide a signal indicative of a malfunction in PVA1, such as a current flowing from the busbar 40 back toward the input PVA1. The current flow from the busbar 40 back through an input is generally indicative of a fault; moreover, the current backflow may be less than the level at which the fuse 31 is rated, so the fuse 31 will not disconnect the circuit from the busbar 40. Accordingly, the sensor 61 may be configured to determine whether there is a flow of current from the busbar 40 back to an input. The current sensor assembly 60 may compare the signal against a threshold to evaluate whether the magnitude of the reverse current flow is indicative of a malfunction.

In addition, it may be desirable to automatically disconnect a malfunctioning source, e.g., PVA1, from the re-combiner box 20 in response to a reverse current detected by the associated current sensor assembly 60. Accordingly, a contactor 115 may be placed in the circuit between the input circuit connection and the positive terminal assembly 30, FIGS. 1, 3. For instance, the system 10 may include a separate contactor 115 for each input circuit connected to the busbar 40. As an alternative, the current sensor assemblies 60 may be provided in electrical communication with the negative terminal assembly 24 and contactors 115 in electrical communication with the positive terminal assembly 30, or vice versa. Optionally, the contactors 115 and over-current protection elements 31 may be provided in the form of a shunt trip capable circuit breaker. The contactor 115 may include one or more normally open switches, so that the input from an output circuit PVA1-PVA12 is normally switched off and disconnected from the re-combiner box 20. An exemplary contactor 115 may be configured to handle 400 Amps and 1000 volts. A power supply 120 may provide power to the contactors 115 to energize the contactors 115 to close so that current can flow from the output circuits PVA1-PVA12 to the busbar 40 to be re-combined. If the power to the contactors 115 from the power supply 120 is interrupted, the contactors 115 will open the circuit to prevent the flow of electricity to or from one or more of the output circuits PVA1-PVA12.

A particular contactor 115 between a particular input and the busbar may be switched off if the current sensor assembly 60 associated with the particular contactor 115 detects a reverse current outside of an acceptable range. By way of example, if the current sensor 61 detects a current less than zero, the current indicates that current is flowing back through the circuit, from the busbar 40 to the output circuits PVA1-PVA12. More generally, if the sensor 61 detects a current below a threshold then the reduced current may be indicative of a fault in the source circuit. The threshold may be zero or alternatively may be some value less than zero, such as a threshold indicating a current flow of 10 or more amps from the busbar 40 back toward an output circuit PVA1-PVA12. In response to the detected current falling below a predetermined level, the circuit from the output circuit PVA1-PVA12 to the busbar 40 may be automatically interrupted. Specifically, the current sensor assembly 60 may include a switch or may be operable to control the associated contactor 115 to disconnect the power from the power supply 120. Once the power from the power supply 120 to the contactor 115 is interrupted, the contactor 115 may automatically switch to an open position, thereby opening the circuit between the input and the busbar 40.

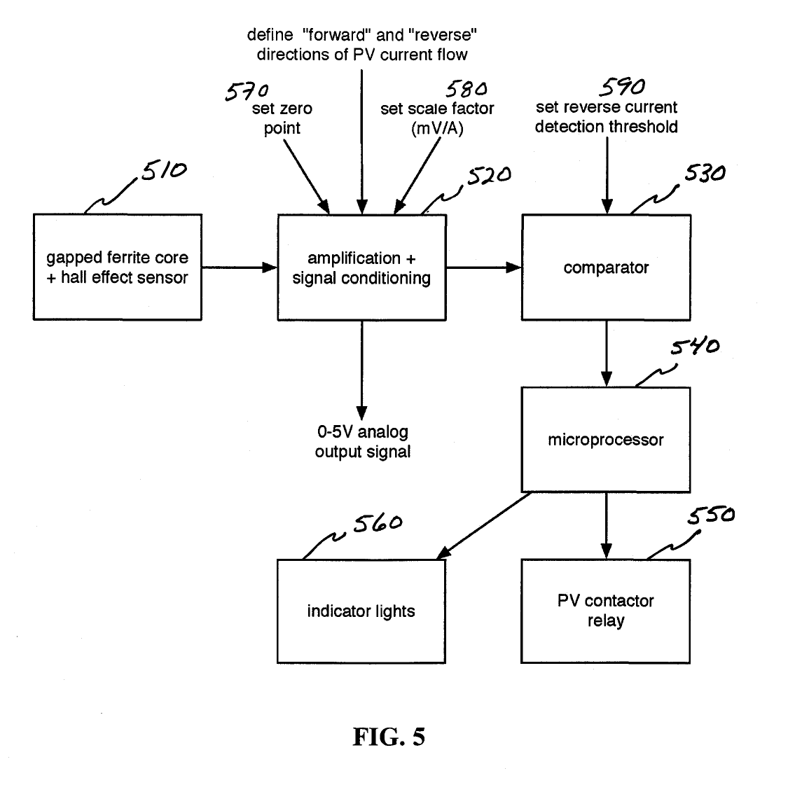

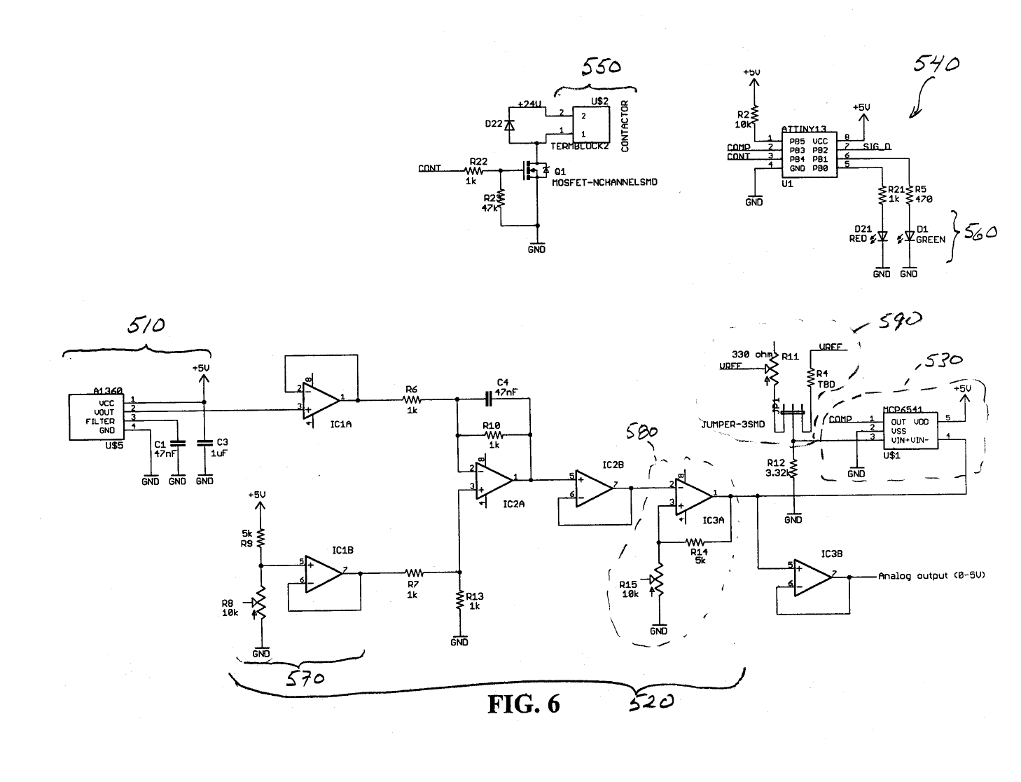

Turning to exemplary control circuitry that may be provided on the circuit board 63, FIG. 6 schematically illustrates circuit diagrams that may be used to implement reverse current sensing and isolation of a detected malfunctioning input, e.g., PVA1, from the system 10. The function of the circuits illustrated in FIG. 6 may be better understood when viewed in connection with FIG. 5. In particular, the gapped toroid (ferrite) core 62 and current sensor 61 may be provided at circuit element 510. A current detected by the current sensor 61 at circuit element 510 may be provided to circuit element 520 for amplification and signal conditioning. In addition, as part of the amplification and signal conditioning, circuit element 520 may provide a set zero point at element 570 and a scale factor at element 580. In this regard, circuit element 520 may define the “forward” and “reverse” directions of current flow in the system 10. After amplification, the current detected by the current sensor 61 may be analyzed at a comparator 503 to a reverse current threshold set by circuit element 590. The output from the comparator 530 at Pin 1, “COMP”, may be provided as the input to a microprocessor 540 at Pin 2 of the microprocessor 540, FIG. 6. The microprocessor 540 may activate indicator lights 560 to show whether a current fault has occurred or not. If a current fault has been identified by the microprocessor 540, the microprocessor 540 may generate an output signal on Pin 3, “CONT”, that is provided as the input to the contactor relay 550 to cause the contactor relay 550 to open and thereby isolate the current detected by the current sensor 61 from the system 10. The contactor relay 550 of FIGS. 5, 6 may be provided in the form of contactors 115 as illustrated in FIGS. 1-3.

Additionally, the system 10 may include a data communication element so that signals from the current monitoring assemblies 60 may be exported to a data logging element. For instance, the current monitoring assemblies 60 may include a communication element for providing a signal using a common protocol, such as ModBus for communicating the sensor data to a remote device, such as a ModBus capable data logger, inverter or power meter. The remote device may log and/or analyze the data from the circuit board 63 to determine whether the data indicates an error or malfunction in one or more of the power input elements (i.e. PVA1-PVA12), as well as identifying which of the input elements should be analyzed to determine if there is a malfunction. The remote device may then provide signals or warnings to the operator indicating the detected malfunction and which power input element(s) appear to have a malfunction or other performance issue.

Further, the circuit may include a data logger that logs data regarding the signal sensed for each sensor 61 in the sensor assembly 60. The user may analyze the data recorded by the data logger for each sensor 61 to determine which sensor 61 caused the shut down. Additionally, the circuit may be configured so that the data logger logs data received from the current sensing assembly identifying which sensor 61 triggered the shut down.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. For example, while the invention has been exemplified in the context of a re-combiner box 20, the system of the present invention, such as current sensor monitor 60, contactor 115, and over-current protection element 31, may also be utilized in other devices, such as combiner boxes (e.g., string combiner box Part No. CS-12-15-N3 sold by SolarBOS, Inc.) It should therefore be understood that this invention is not limited to the particular embodiments described herein, but is intended to include all changes and modifications that are within the scope and spirit of the invention as set forth in the claims.

1. A system for sensing and interrupting a reverse current produced by a plurality of photovoltaic elements, comprising:
a plurality of sensors each disposed in electrical communication with a respective conductor of a first polarity, the sensors configured to detect the direction of the current flow in the respective conductor of a first polarity and configured to provide an output of the detected direction of the current; and
a plurality of switches each disposed in electrical communication with a respective one of the sensors to receive the detected direction of the current and configured to disconnect the current from the respective conductor of the first polarity responsive to the detected direction.

2. The system of claim 1, wherein the plurality of switches configured to disconnect the current from the respective conductor of the first polarity when the detected direction is reverse to the correct direction of current flow.

3. The system of claim 1, comprising a first busbar for electrical communication with each of the conductors of a first polarity so that the direct current from the photovoltaic elements is combined to form a single current at the busbar.

4. The system of claim 3, wherein each of the plurality of sensors is disposed between the first busbar and an associated switch of the plurality of switches.

5. The system of claim 3, comprising a second busbar for electrical communication with a conductor of a second polarity opposite the first polarity, wherein each of the plurality of sensors is disposed in electrical communication with the first busbar and each of the plurality of switches is disposed in electrical communication with the second busbar.

6. The system of claim 1, comprising a comparator disposed in electrical communication with a respective sensor and respective switch to receive the detected direction of the current flow, the comparator configured to turn the switch off in case of reverse current flow.

7. The system of claim 1, comprising a plurality of over-current protection elements each electrically connected with a respective one of the conductors of a first polarity, wherein the over-current protection elements are operable to create an open circuit in the event a current passing therethrough exceeds a threshold.

8. The system of claim 7, wherein the over-current protection elements comprise fuses.

9. The system of claim 7, wherein the over-current protection elements comprise circuit breakers.

10. The system of claim 7, wherein the over-current protection elements and switches comprise shunt trip capable circuit breakers.

11. The system of claim 1, wherein the plurality of switches comprises a plurality of contactors.

12. The system of claim 1, wherein the plurality of switches comprises normally open contactors.

13. The system of claim 1, wherein the plurality of sensors comprises Hall effect sensors.

14. The system of claim 1, wherein the plurality of sensors are disposed around the conductors of a first polarity.

15. The system of claim 1, wherein the plurality of sensors are configured to detect the magnitude of the current.
